(19) United States
(12) Patent Application Publication
(10) Pub. No.: US 2005/0044573 A1
(43) Pub. Date: Feb. 24, 2005

(54) [CABLE SIGNAL DISTRIBUTION SYSTEM]

(76) Inventor: Joseph P. Preschutti, Boalsburg, PA (US)

Correspondence Address: JOHN J. ELNITSKI, JR., 225 A SNOWBIRD LANE, BELLEFONTE, PA, 16823, US

(21) Appl. No.: 10/604,842

(22) Filed: Aug. 21, 2003

(51) Int. Cl. H04N 7/18; H04N 7/173

(52) U.S. Cl. 725/78; 725/74; 725/120; 725/127

(57) ABSTRACT

A cable signal distribution system to allow the distribution of a digital cable signal in a building using the existing cable network in the building. The cable signal distribution system is a low cost system coupled with simple functionality. The cable signal distribution system splits the initial cable signal frequency range into two separate bands, a low band for operating cable television system-related equipment, and a higher frequency band used to create a Home Band Network of cable frequencies within the cable signal frequency range. The Home Band Network is used to transmit the channel tuned by the CATV digital set top box to existing analog Televisions in the building.

### CROSS REFERENCE TO RELATED APPLICATIONS

This application claims the benefit of and incorporates by reference U.S. Provisional Application No. 60/319,485 filed Aug. 22, 2002.

### BACKGROUND OF INVENTION

The present invention generally relates to transmission of signals along a coaxial cable system. More specifically, the present invention relates to a system which distributes signals within a building from an outside source.

The development of digital signals transmitted by the cable television (CATV) industry to homes and other buildings requires the use of a CATV digital set top box in most cases. The digital set top box is required because most of the currently owned televisions are not compatible with the digital signal. Also, the digital set top box must be used to take advantage of pay-per-view systems. The digital set top box is usually located at the television where the programming is to be viewed. This means that either every television in a building must have a digital set top box or new cables must be run to each television from a cable signal splitter emanating from the digital set top box. To have a digital set top box at each television, increases the costs paid by the consumer to the cable company. Most consumers will opt to use a cable signal splitter. The problem posed by the cable signal splitter is that it requires the running of new cable to other rooms of the building, which can be a difficult task in an existing building.

It is an object of the present invention to provide a signal distribution system which can be added to an existing cable network in a building in order to allow the distribution of a digital signal without re-cabling the building.

### SUMMARY OF INVENTION

A cable signal distribution system used in combination with an existing cable network in a building, cable device input in the building connected to the existing cable network to supply at least one cable device, cable signal input from outside the building connected to the existing cable network to provide an initial cable signal into the building and a CATV digital set top box. The cable signal distribution system includes a turn-around splitter having an input and at least two outputs, where the input is connected to the cable signal input. A first of at least two outputs of the turn-around splitter is connected to the cable device input by a first coaxial cable. A second of at least two outputs of the turn-around splitter is connected to a second coaxial cable to provide a path between the turn-around splitter and the CATV digital set top box. The turn-around splitter includes band splitting electronics to divide the initial cable signal into a high frequency band and a low frequency band as the initial cable signal enters the input of the turn-around splitter. The turn-around splitter terminates the high frequency band of the incoming initial cable signal. A reverse transmitting device is connected between the second coaxial cable and the CATV digital set top box. The reverse transmitting device is configured to receive the output cable signal from the CATV digital set top box and configured to convert and transmit the output cable signal from the CATV digital set top box as a converted output cable signal on a frequency in a range of the high frequency band to the second of the at least two outputs of the turn-around splitter. The first of the at least two outputs connected to the second of the at least two outputs of the turn-around splitter such that the converted output cable signal from the reverse transmitting device transmitted on the range of the high frequency band to the second of the at least two outputs of the turn-around splitter on the second coaxial cable is transmitted to the first of the at least two outputs of the turn-around splitter and onto the cable device input by the first coaxial cable to feed the at least one cable device in the building with the converted output cable signal from the CATV digital set top box.

### BRIEF DESCRIPTION OF DRAWINGS

FIG. 1 is a schematic view of an example of a cable signal distribution system according to the present invention.

FIG. 2 is a schematic view of a Video Hub according to the present invention.

FIG. 3 is a schematic view of a Turn-Around Splitter according to the present invention.

FIG. 4 is a schematic view of a Cable-Connected IR POD according to the present invention.

FIG. 5 is a circuit diagram of a Turn-Around Splitter according to the present invention.

### DETAILED DESCRIPTION

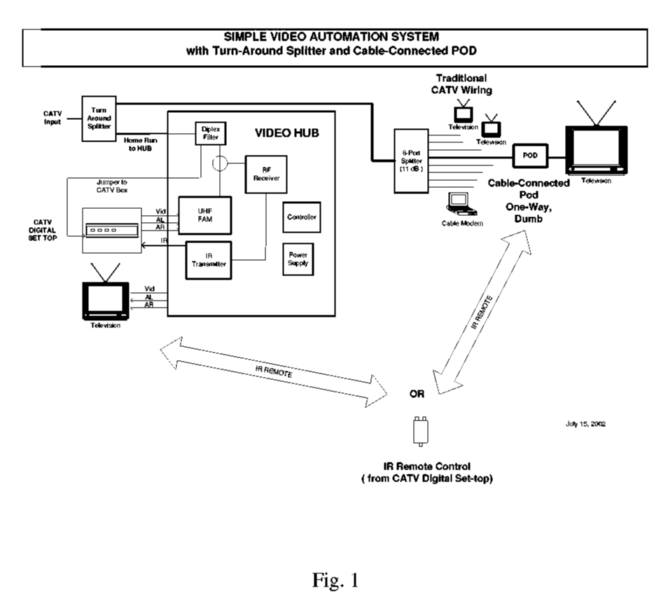

The present invention is a cable signal distribution system, as shown in FIGS. 1-5. The cable signal distribution system allows the distribution of a digital cable signal in a building using the existing cable network in the building. The cable signal distribution system is a low cost system coupled with simple functionality. The cable signal distribution system splits the initial cable signal frequency range into two separate bands, a low band for operating cable television system-related equipment, and a higher frequency band used to create a Home Band Network of cable frequencies within the cable signal frequency range. The Home Band Network is used to transmit the channel tuned by the CATV digital set top box to existing analog Televisions in the building, shown connected to an eight Port Splitter. OLE_LINK1 FIG. 1 shows a schematic example of the layout of the cable signal distribution system according to the present invention. FIG. 1 shows a Turn-Around Splitter, Video Hub, CATV digital set top box, Local Television attached to the Video Hub, eight Port Splitter, additional analog Televisions connected to the eight Port Splitter, Cable-Connected POD and IR Remote Control for the CATV digital set top box. The CATV digital set top box is connected to the Video Hub, which has a home-run connection back to the Turn-Around Splitter. The home-run connection is a direct link from the CATV digital set top box to the Turn-Around Splitter. The initial cable signal from outside the building is connected to the Turn-Around Splitter at an entry point of the building. The cable device input used to feed existing cable devices in the building is connected to one port of the Turn-Around Splitter. Examples of existing cable devices are televisions or cable modems. The input of the eight Port Splitter is shown as an example of the cable device input of a building, but the cable device input could be as simple as a connection to one television. While, the Video Hub is connected to the other output of the Turn-Around Splitter. The IR Remote Control from the CATV digital set top box is used anywhere in the home via the Cable-Connected POD. The Cable-Connected POD is a “dumb” translator communicating via UHF-RF signals in the higher frequency band of the Home Band Network along the existing cabling from the Cable-Connected POD at each television to an IR Transmitter in the Video Hub. The Cable-Connected POD does nothing except repeat the signal that is being generated by the IR Remote Control.

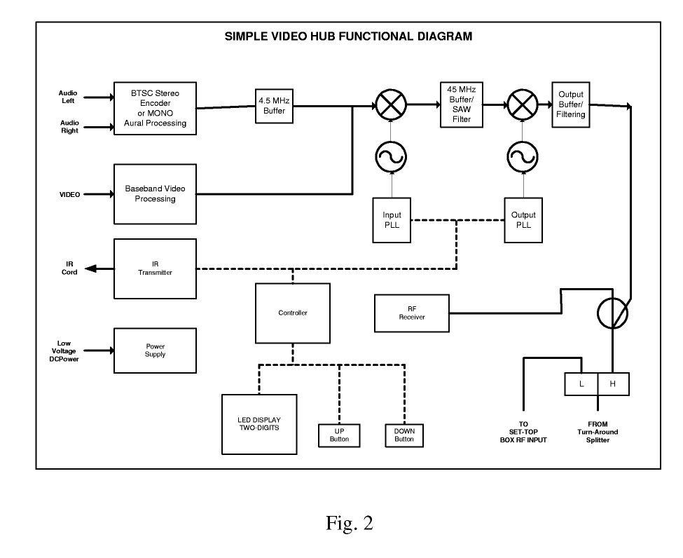

OLE_LINK1 The Video Hub is shown schematically in FIGS. 1-2 and acts as a reverse transmitting device between the Turn-Around Splitter and the CATV digital set top box. The Video Hub is configured to receive an output cable signal from the CATV digital set top box. The Video Hub is also configured to convert and transmit the output cable signal from the CATV digital set top box as a converted output cable signal on a frequency in a range of the high frequency band back to the Turn-Around Splitter on the same coaxial cable acting as the link between the Video Hub and the Turn-Around Splitter. The Video Hub includes a UHF Frequency Agile Modulator, a circuit to receive the cabled IR/RF signal from the IR remote, an output to deliver IR commands to the CATV digital set top box, an output to connect to the CATV digital set top box, an input from the Turn-Around Splitter, and appropriate power and control circuitry. The UHF Frequency Agile Modulator operates at standard UHF frequency assignments for channels between 750 and 860 MHz. The Video Hub may contain a SAW Filter and have vestigial sideband response, or may not contain a SAW filter to save cost, and then have a double-sideband RF output occupying two channels. Features include a two-digit LED display, and up/down channel selector buttons for selecting the output channel. The Simple Video Hub coaxial input circuits contains a Diplex Filter to separate the frequencies of the Home Band Network from the rest of the frequencies of the cable signal.

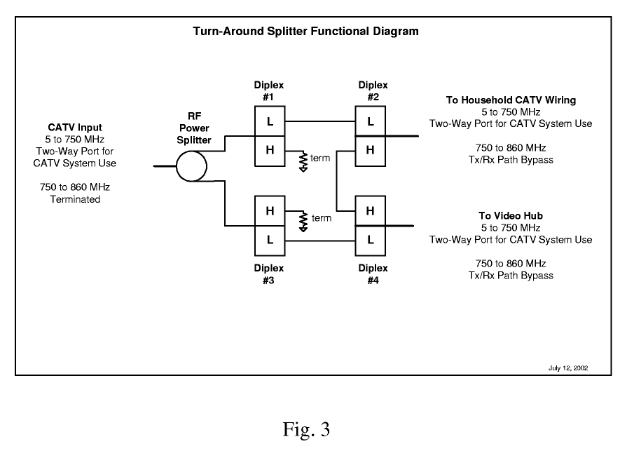

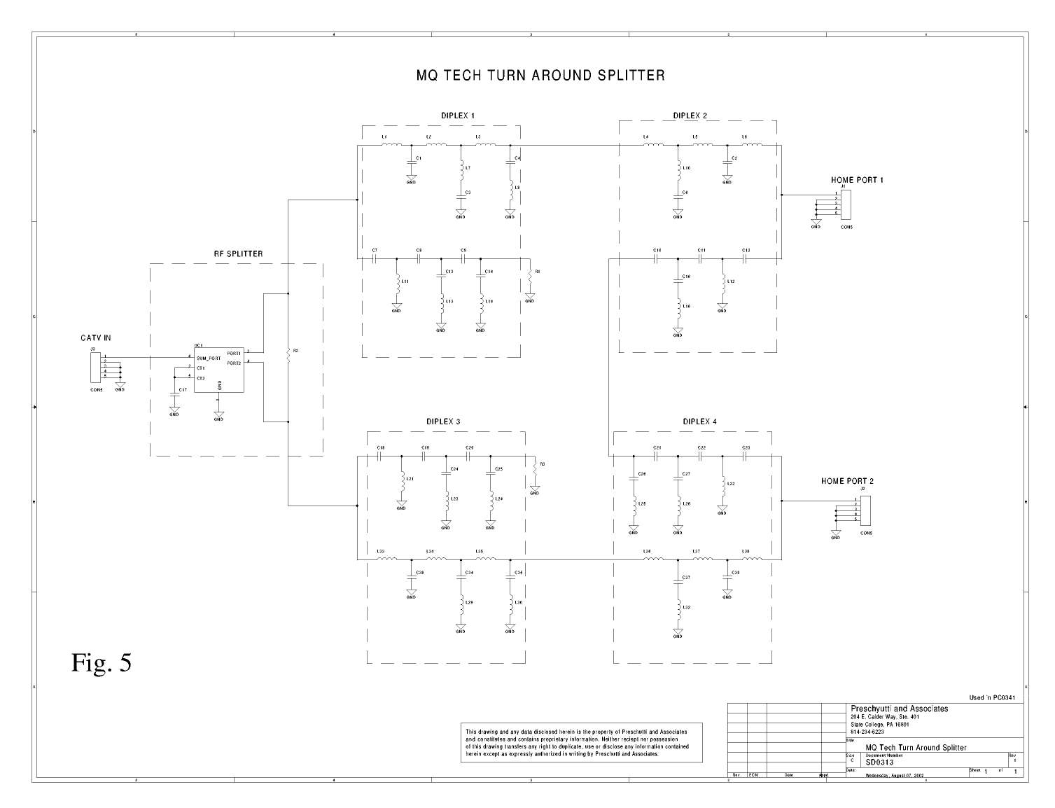

FIG. 3 schematically shows the Turn-Around Splitter. The Turn-Around Splitter includes band splitting electronics to split the initial cable signal into separate bands. The Turn-Around Splitter has an input port and two output ports. The input port of the Turn-Around Splitter is provided by a standard CATV RF Power Splitter. The input port receives the initial cable signal from outside the building and passes the initial cable signal into the CATV RF Power Splitter. The output ports of the CATV RF Power Splitter are interconnected with four separate Diplexing Filters, as shown in the functional diagram of FIG. 3. The Diplex Filters each have a Common Port, Low-Pass Port (L) and a High-Pass Port (H). The Common Port passes both High and Low frequency bands and is used as an input or output, depending on the orientation of each Diplex Filter. The Low-Pass Port passes low frequencies and stops high frequencies. The High-Pass Port passes high frequencies and stops low frequencies. Normally, the output ports of the CATV RF Power Splitter are isolated from each other, so that signals entering one output port are significantly and purposely attenuated at the other output port. Signals coming from outside the building and into the input port of the Turn-Around Splitter are split into two paths, with half of the power delivered to each of the output ports of the Turn-Around Splitter. With a standard cable signal splitter, signals generated in the reverse direction to an output port from a device have half of the power delivered thru the output port and onto the input port of the splitter, while the other half of the power is terminated in an internal resistor, rather than delivered to the other output port. The Turn-Around Splitter has the output ports inter-connected together to form the Home Band network of higher frequencies for frequencies above a certain value, say 750 MHz, while maintaining a similar port-to-port isolation of the standard splitter which is desired for normal CATV system operation in the Low Frequency Band. This interconnection is accomplished by connecting the High ports of Diplexers 2 and 4 together. Diplex Filters 1 and 3 have their common ports connected to the output ports of the CATV RF Power Splitter, and provide for a good impedance match across the band at the input of the CATV RF Power Splitter by terminating the High Frequencies used as the Home Band Network of frequencies. Furthermore the Diplexers serve to prevent the internally-generated RF signals in the Home Band Network from going out into the existing cable network. FIG. 5 shows a circuit diagram of one possible way to electronically implement the Turn-Around Splitter.

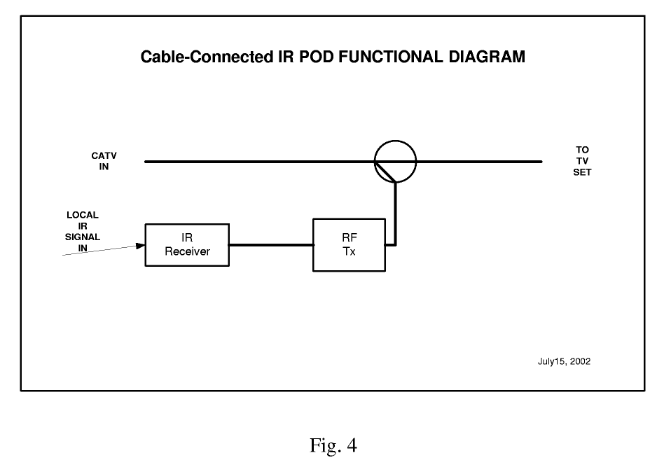

The Cable-Connected IR POD is schematically shown in FIG. 4 and is connected to each remote Television in the building. The POD receives locally-generated IR signals at each remote Television and then relays them back to the Video Hub using a channel in the High Frequency Band, in the reverse direction along the existing cable network emanating from the eight port splitter. At the Video Hub, the IR channel RF signals are converted to an IR signal and sent to the CATV digital set top box. The POD is powered from a low-voltage power pack.

The cable signal distribution system operates as follows. The initial cable signal enters the building and feeds the Turn-Around Splitter. The Turn-Around Splitter is the major component which allows the use of an existing cable network in a building. The initial signal is fed into the CATV RF Power Splitter of the Turn-Around Splitter, which splits the signal to Diplex #1 and Diplex #3. Diplex #1 and Diplex #3 are designed to only allow a preset of lower frequencies of the initial cable signal to pass to Diplex #2 and Diplex #4, respectively. The preset lower frequencies usually contain the analog and digital channels to be watched on televisions. Diplex #2 allows the preset lower frequencies to pass to the eight Port Splitter, which feeds the existing cable devices on the existing cable network. Diplex #4 allows the preset lower frequencies to pass to the Video Hub. The Video Hub allows transmission of the preset lower frequencies to the CATV digital set top box for viewing of the analog and digital channels. The CATV digital set top box feeds back the channel selected to be viewed to the Video Hub and the Video Hub transmits the channel to be viewed to the Local Television which is local to the CATV digital set top box. The CATV digital set top box could also be directly connected to the Local Television. The Video Hub also transmits the channel to be viewed back along the cable between the Video Hub and Turn-Around Splitter as a converted output cable signal at a frequency which is higher than the preset lower frequencies. The higher frequency carrying the selected channel enters Diplex #4 and is passed to Diplex #2. The higher frequency carrying the selected channel exits Diplex #2 and enters cable input device shown as the eight Port Splitter on an existing cable of the existing cable network to be distributed to the additional analog Television without the need for new cabling or additional CATV digital set top boxes. Cable-Connected IR PODs located at each additional analog Television allows the selected channel on the CATV digital set top box to be changed. The LED Display, channel up and channel down on the Video Hub controls the channel of the Higher Frequencies on which the selected channel of CATV digital set top box is transmitted upon out to the Turn-Around Splitter.

While different embodiments of the invention have been described in detail herein, it will be appreciated by those skilled in the art that various modifications and alternatives to the embodiments could be developed in light of the overall teachings of the disclosure. Accordingly, the particular arrangements are illustrative only and are not limiting as to the scope of the invention that is to be given the full breadth of any and all equivalents thereof.

1. A cable signal distribution system, in combination with an existing cable network in a building, cable device input in the building connected to the existing cable network to supply at least one cable device, cable signal input from outside the building connected to the existing cable network to provide an initial cable signal into the building and a CATV digital set top box, comprising:
a turn-around splitter including an input and at least two outputs, said input connected to the cable signal input;
a first of at least two outputs of said turn-around splitter connected to the cable device input by a first coaxial cable;
a second of at least two outputs of said turn-around splitter connected to a second coaxial cable to provide a path between said turn-around splitter and the CATV digital set top box;
said turn-around splitter including band splitting electronics to divide the initial cable signal into a high frequency band and a low frequency band as the initial cable signal enters said input of said turn-around splitter;
said band splitting electronics having the capability to transmit said low frequency band out said at least two outputs of said turn-around splitter, said band splitting electronics having the capability to terminate said high frequency band of said initial cable signal entering said turn-around splitter and prevent transmission of said high frequency band of the initial cable signal entering said turn-around splitter to said at least two outputs of said turn-around splitter, said band splitting electronics having the capability to receive a frequency in a range of said high frequency band at said second of said at least two outputs of said turn-around splitter which is transmitted on said second coaxial cable towards said second of said at least two outputs of said turn-around splitter and redirect said frequency in a range of said high frequency band to said first of said at least two outputs of said turn-around splitter;
a reverse transmitting device connected between said second coaxial cable and the CATV digital set top box, said reverse transmitting device configured to receive the output cable signal from the CATV digital set top box, said reverse transmitting device configured to convert and transmit the output cable signal from the CATV digital set top box as a converted output cable signal on a frequency in a range of said high frequency band to said second of said at least two outputs of said turn-around splitter; and
said first of said at least two outputs connected to said second of said at least two outputs of said turn-around splitter such that said converted output cable signal from said reverse transmitting device transmitted on the range of said high frequency band to said second of said at least two outputs of said turn-around splitter on said second coaxial cable is transmitted to said first of said at least two outputs of said turn-around splitter and onto the cable device input by said first coaxial cable to feed said at least one cable device in the building with said converted output cable signal from the CATV digital set top box.

2. The cable signal distribution system of claim 1, wherein said band splitting electronics includes an internal splitter having an input and at least two outputs;
wherein said input of said internal splitter is connected to said input of said turn-around splitter to receive the initial cable signal; wherein the initial cable signal is split between said at least two outputs of said internal splitter;
wherein said band splitting electronics includes an input diplex filter for each of said at least two outputs of said internal splitter, each of said input diplex filters configured to divide the initial cable signal into said high frequency band and said low frequency band, each of said input diplex filters configured to pass said low frequency band and terminate said high frequency band of the initial cable signal; wherein said band splitting electronics includes an output diplex filter connected to each of said input diplex filters to receive said low frequency band, said output diplex filters connected together to transmit said converted output cable signal in the range of said high frequency band, said output diplex filters each having a output connected to one of said at least two outputs of said turn-around splitter to transmit said low frequency band of the initial cable signal to said the cable device input and the CATV digital set top box, and also transmit said converted output cable signal to the cable device input.

3. The cable signal distribution system of claim 1, wherein said reverse transmitting device is a video hub, said video hub having the capability to receive said low frequency band from said second of said at least two outputs of said turn-around splitter on said second coaxial cable and transmit said low frequency band to said CATV digital set top box, said video hub having the capability to receive the output signal from said CATV digital set top box and transmit the output signal from said CATV digital set top box on said second coaxial cable as said converted output cable signal to said second of said at least two outputs of said turn-around splitter on said high frequency band.

4. The cable signal distribution system of claim 1, wherein said reverse transmitting device is a transmitting means for receiving said low frequency band from said second of said at least two outputs of said turn-around splitter on said second coaxial cable and transmitting said low frequency band to said CATV digital set top box, said transmitting means for receiving the output signal from said CATV digital set top box and transmitting the output signal from said CATV digital set top box on said second coaxial cable as said converted output cable signal to said second of said at least two outputs of said turn-around splitter on said high frequency band.

5. The cable signal distribution system of claim 2, wherein said reverse transmitting device is a video hub, said video hub having the capability to receive said low frequency band from said second of said at least two outputs of said turn-around splitter on said second coaxial cable and transmit said low frequency band to said CATV digital set top box, said video hub having the capability to receive the output signal from said CATV digital set top box and transmit the output signal from said CATV digital set top box on said second coaxial cable as said converted output cable signal to said second of said at least two outputs of said turn-around splitter on said high frequency band.

6. The cable signal distribution system of claim 2, wherein said reverse transmitting device is a transmitting means for receiving said low frequency band from said second of said at least two outputs of said turn-around splitter on said second coaxial cable and transmitting said low frequency band to said CATV digital set top box, said transmitting means for receiving the output signal from said CATV digital set top box and transmitting the output signal from said CATV digital set top box on said second coaxial cable as said converted output cable signal to said second of said at least two outputs of said turn-around splitter on said high frequency band.

7. A method of distributing a digital cable signal in a building using the existing cable network in the building, comprising:
receiving an initial cable signal into a building and feeding the initial cable signal into an input of a turn-around splitter,
splitting the initial cable signal into a high frequency band and a low frequency band at the turn-around splitter, whereby the turn-around splitter includes band splitting electronics to divide the initial cable signal into the high frequency band and the low frequency band as the initial cable signal enters the input of said turn-around splitter;
terminating the high frequency band from the initial cable signal to prevent transmission of any signals from the initial cable signal in a range of the high frequency band;
transmitting the low frequency band to a CATV digital set top box and other cable devices through outputs of the turn-around splitter using a coaxial cable for each output;
receiving an output signal from the CATV digital set top box through the same cable used to transmit the low frequency band to the CATV digital set top box;
converting the output signal from the CATV digital set top box to a converted output cable signal be transmitted in the range of the high frequency band to the turn-around splitter;
transmitting said converted output signal to the turn-around splitter in the range of the high frequency band through the same cable used to transmit the low frequency band to the CATV digital set top box; and
transmitting said converted output signal to the other outputs of the turn-around splitter from the output connected to the CATV digital set top box.

8. The method of claim 7, wherein said band splitting electronics includes an internal splitter having an input and at least two outputs; wherein said input of said internal splitter is connected to said input of said turn-around splitter to receive the initial cable signal; wherein the initial cable signal is split between said at least two outputs of said internal splitter; wherein said band splitting electronics includes an input diplex filter for each of said at least two outputs of said internal splitter, each of said input diplex filters configured to divide the initial cable signal into said high frequency band and said low frequency band, each of said input diplex filters configured to pass said low frequency band and terminate said high frequency band of the initial cable signal; wherein said band splitting electronics includes an output diplex filter connected to each of said input diplex filters to receive said low frequency band, said output diplex filters connected together to transmit said converted output cable signal in the range of said high frequency band, said output diplex filters each having a output connected to one of said at least two outputs of said turn-around splitter to transmit said low frequency band of the initial cable signal to said the cable device input and the CATV digital set top box, and also transmit said converted output cable signal to the cable device input.

9. The method of claim 7, wherein said reverse transmitting device is a video hub, said video hub having the capability to receive said low frequency band from said second of said at least two outputs of said turn-around splitter on said second coaxial cable and transmit said low frequency band to said CATV digital set top box, said video hub having the capability to receive the output signal from said CATV digital set top box and transmit the output signal from said CATV digital set top box on said second coaxial cable as said converted output cable signal to said second of said at least two outputs of said turn-around splitter on said high frequency band.

10. The method of claim 7, wherein said reverse transmitting device is a transmitting means for receiving said low frequency band from said second of said at least two outputs of said turn-around splitter on said second coaxial cable and transmitting said low frequency band to said CATV digital set top box, said transmitting means for receiving the output signal from said CATV digital set top box and transmitting the output signal from said CATV digital set top box on said second coaxial cable as said converted output cable signal to said second of said at least two outputs of said turn-around splitter on said high frequency band.

11. The method of claim 8, wherein said reverse transmitting device is a video hub, said video hub having the capability to receive said low frequency band from said second of said at least two outputs of said turn-around splitter on said second coaxial cable and transmit said low frequency band to said CATV digital set top box, said video hub having the capability to receive the output signal from said CATV digital set top box and transmit the output signal from said CATV digital set top box on said second coaxial cable as said converted output cable signal to said second of said at least two outputs of said turn-around splitter on said high frequency band.

12. The method of claim 8, wherein said reverse transmitting device is a transmitting means for receiving said low frequency band from said second of said at least two outputs of said turn-around splitter on said second coaxial cable and transmitting said low frequency band to said CATV digital set top box, said transmitting means for receiving the output signal from said CATV digital set top box and transmitting the output signal from said CATV digital set top box on said second coaxial cable as said converted output cable signal to said second of said at least two outputs of said turn-around splitter on said high frequency band.
